(19) United States
(12) Patent Application Publication
(10) Pub. No.: US 2024/0319506 A1
(43) Pub. Date: Sep. 26, 2024

(54) AIR POCKET STRUCTURES FOR PROMOTING TOTAL INTERNAL REFLECTION IN A WAVEGUIDE

(71) Applicant: Magic Leap, Inc., Plantation, FL (US)

(72) Inventors: Xiaopei DENG, Cedar Park, TX (US); Vikramjit SINGH, Pflugerville, TX (US); Shuqiang YANG, Austin, TX (US); Kang LUO, Austin, TX (US); Nai-Wen PI, Plano, TX (US); Frank Y. Xu, Austin, TX (US)

(73) Assignee: Magic Leap, Inc., Plantation, FL (US)

(21) Appl. No.: 18/679,328

(22) Filed: May 30, 2024

Related U.S. Application Data
(63) Continuation of application No. 17/416,248, filed on Jun. 18, 2021, now Pat. No. 12,044,851.
(60) Provisional application No. 62/783,778, filed on Dec. 21, 2018.

(51) Int. Cl. G02B 27/01; G02B 6/10; G02B 6/122; G02B 6/13; G02B 27/00

(52) U.S. Cl. CPC G02B 27/0172; G02B 6/0011; G02B 6/1223; G02B 6/13; G02B 27/0081; G02B 6/10; G02B 2027/0174

(57) ABSTRACT

Recesses are formed on a front side and a rear side of a waveguide. A solid porogen material is spun onto the front side and the rear side and fills the recesses. First front and rear cap layers are then formed on raised formations of the waveguide and on the solid porogen material. The entire structure is then heated and the solid porogen material decomposes to a porogen gas. The first front and rear cap layers are porous to allow the porogen gas to escape and air to enter into the recesses. The air maximizes a difference in refractive indices between the high-index transparent material of the waveguide and the air to promote reflection in the waveguide from interfaces between the waveguide and the air.

### CROSS-REFERENCE TO RELATED APPLICATIONS

This application is a continuation of U.S. patent application Ser. No. 17/416,248, filed on Jun. 18, 2021, which is a National Phase of International Application No. PCT/US2019/067919, filed on Dec. 20, 2019, which claims priority from U.S. Provisional Patent Application No. 62/783,778, filed on Dec. 21, 2018, all of which are incorporated herein by reference in their entirety.

### BACKGROUND OF THE INVENTION

### 1). Field of the Invention

This invention relates generally to an optical system and to a method of manufacturing an optical system.

### 2). Discussion of Related Art

Modern computing and display technologies have facilitated the development of so called “augmented reality” viewing devices. Such a viewing device usually has a frame that is mountable to a head of a user and frequently include two waveguides, one in front of each eye of a viewer. The waveguides are transparent so that ambient light from objects can transmit through the waveguides and the user can see the objects. Each waveguide also serves to transmit projected light from a projector to a respective eye of the user. The projected light forms an image on the retina of the eye. The retina of the eye thus receives the ambient light and the projected light. The user simultaneously sees real objects and an image that is created by the projected light.

The projected light usually enters the waveguide on an edge of the waveguide, then reflects within the waveguide and then exits the waveguide through a pupil of the waveguide towards the eye of the user. Total internal reflection (TIR) is an ideal situation where there are no losses of the projected light out of the waveguide and 100 percent of the projected light reaches the eye of the user.

### SUMMARY OF THE INVENTION

The invention provides a method of manufacturing an optical system including securing a cap layer of a select transparent material to a waveguide of a high-index transparent material having front and rear sides, a cavity being defined between the cap layer and the waveguide with an optical gas in the cavity, such that, if a source of ambient light is located on the front side of the waveguide, a beam of the ambient light transmits in the select transparent material of the cap layer, in the cavity holding the optical gas and in the high-index transparent material of the waveguide.

The invention also provides an optical system including a waveguide of a high-index transparent material having front and rear sides, a cap layer of a select transparent material secured to the waveguide, a cavity being defined between the cap layer and the waveguide and an optical gas in the cavity, such that, if a source of ambient light is located on the front side of the waveguide, a beam of the ambient light transmits in the select transparent material of the cap layer, in the cavity holding the optical gas and in the high-index transparent material of the waveguide

### BRIEF DESCRIPTION OF THE DRAWINGS

The invention is further described by way of examples with reference to the accompanying drawings, wherein:

FIG. 1A is a cross-sectional side-view of a waveguide of a high-index transparent material;

FIG. 1B is a view similar to FIG. 1A after the waveguide has been patterned to have a plurality of recesses and raised formations on a front side and a rear side;

FIG. 1C is view similar to FIG. 1B after the recesses are filled with a solid porogen material in spinning process;

FIG. 1D is a view similar to FIG. 1C after a first front cap layer is formed on the front side and a first rear cap layer is formed on the rear side;

FIG. 1E is view similar to FIG. 1D after the structure is heated to remove the solid porogen material and replace the solid porogen material with air;

FIG. 1F is view similar to FIG. 1E after further cap layers are formed on the first front and first rear cap layers to finalize the fabrication of an optical system;

FIG. 1G is a view similar to FIG. 1F of the optical system and shows its functioning;

FIG. 1H is a cross-sectional side view of an optical system according to an alternate embodiment of the invention wherein patterned layers are formed from photoresist material;

FIG. 2 is a cross-sectional side view of an optical system according to an alternate embodiment of the invention having nanostructures to promote absorption of ambient light;

FIG. 3 is a cross-sectional side view similar to FIG. 1F with nanostructures having variable feature height or variable duty cycles;

FIG. 4 is a cross-sectional side view similar to FIG. 2 having nanostructures with variable feature height or variable duty cycles;

FIG. 5 is cross-sectional side view of an optical system having air pockets in different layers;

FIG. 6A is a scanning electron microscope (SEM) image with a single coating;

FIG. 6B is a SEM image of a capped air pocket with a multi-layered coating;

FIG. 7A is a cross-sectional side view of an air pocket capped with a silicon oxide layer and then spin coated with an optical polymer;

FIG. 7B is a view similar to FIG. 7A at a lower magnification level;

FIG. 8 is a 0° transmission graph from experimental measurements;

FIG. 9 is a model that is used for simulation purposes;

FIG. 10A is a side view of a waveguide without any coatings for the simulation;

FIG. 10B is a side view of a waveguide with an optical polymer coating for the simulation;

FIG. 10C is a side view of a waveguide with an air pocket for the simulation;

FIG. 10D is a side view of a waveguide with a polymer instead of an air gap for the simulation;

FIG. 11 is a graph showing transmission data from the simulation; and

FIG. 12 is a graph showing user-side diffraction efficiency from the simulation.

### DETAILED DESCRIPTION OF THE INVENTION

An optical system is described and a method for making the optical system. Recesses are formed on a front side and a rear side of a waveguide. A solid porogen material is spun onto the front side and the rear side and fills the recesses. First front and rear cap layers are then formed on raised formations of the waveguide and on the solid porogen material. The entire structure is then heated and the solid porogen material decomposes to a porogen gas. The first front and rear cap layers are porous to allow the porogen gas to escape and air to enter into the recesses. The air maximizes a difference in refractive indices between the high-index transparent material of the waveguide and the air to promote reflection in the waveguide from interfaces between the waveguide and the air. Second front and rear cap layers are formed on the first front and rear cap layers, respectively and further front and rear cap layers are then formed on the second front and rear cap layers. The cap layers have indices of refraction that promote absorption of ambient light through the cap layers and into the waveguide.

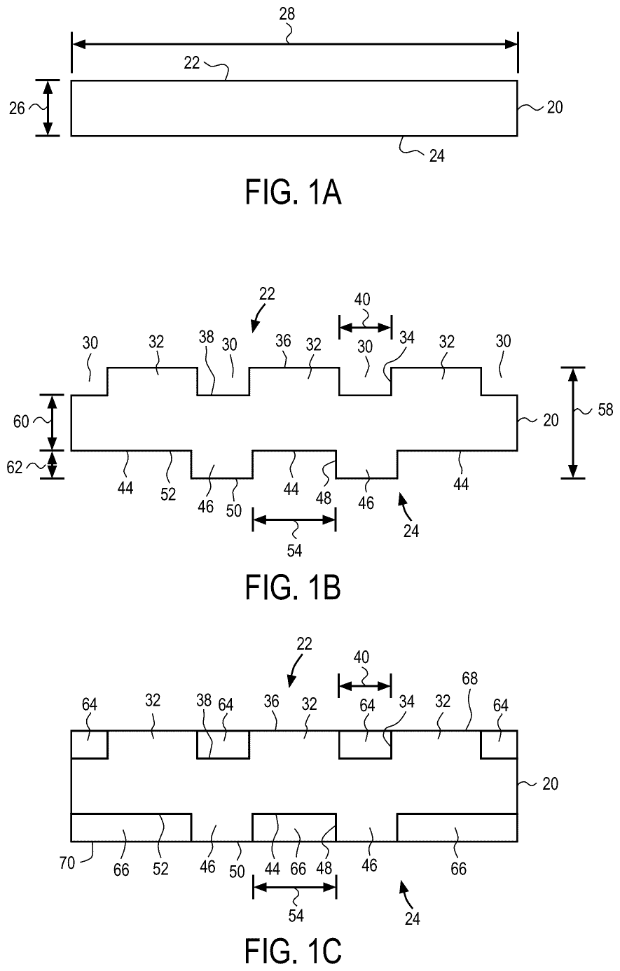

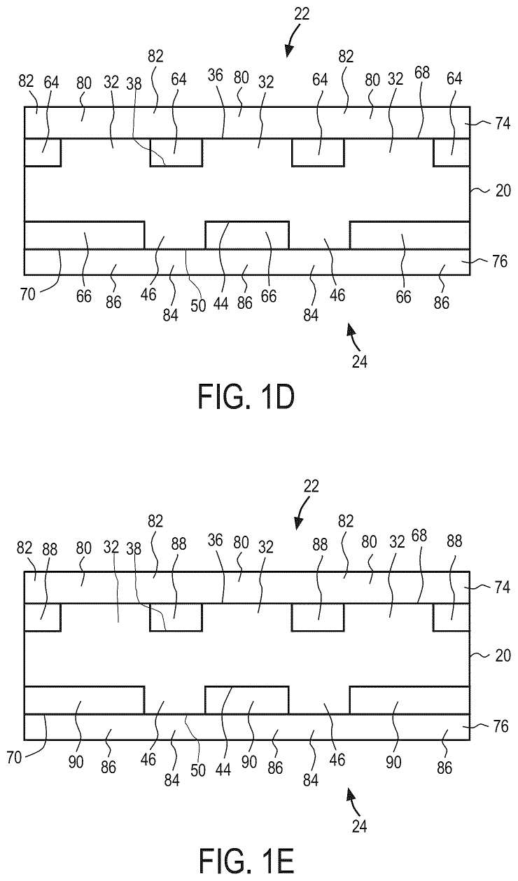

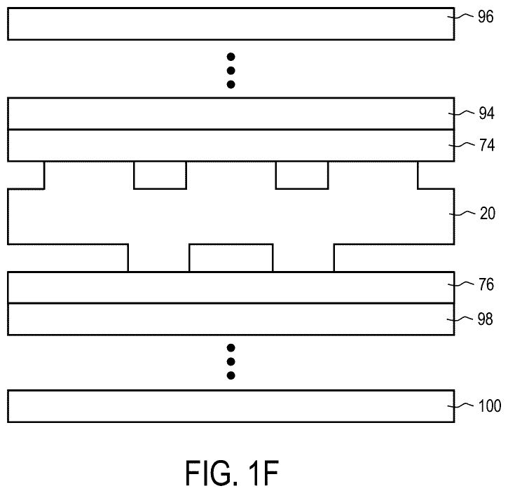

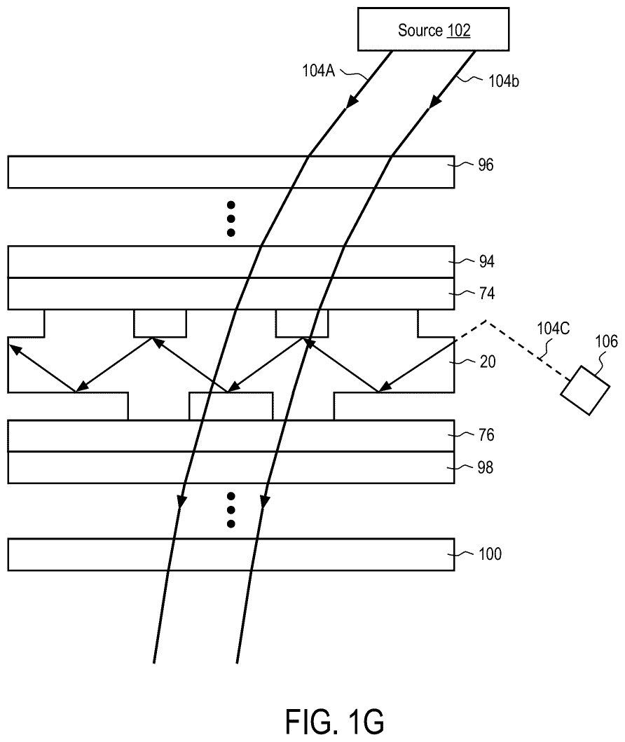

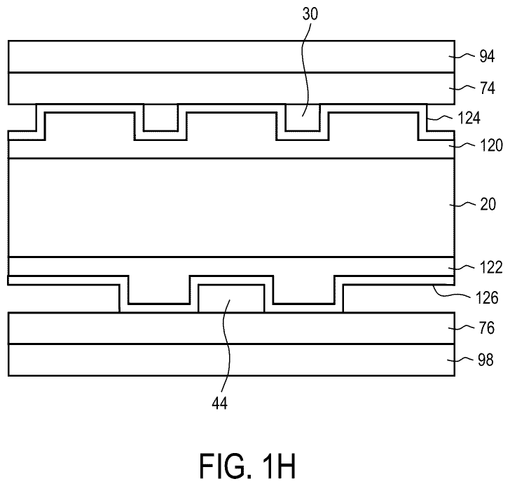

FIGS. 1A to 1F illustrate a method of manufacturing an optical system according to an embodiment of the invention.

FIG. 1A illustrates a waveguide 20 that serves as a primary substrate for subsequent fabrication. The waveguide 20 is made of a high-index transparent material. It is generally contemplated that the index of refraction of the waveguide 20 be at least 1.5. In the present embodiment, the waveguide 20 is made of high-index glass having an index of refraction of 1.73. In another embodiment, a waveguide may be made of lithium niobate, lithium tantalite or silicon carbide having an index of refraction of more than 2.0. A high-index transparent material is preferred because it maximizes field-of-view in the final product.

The waveguide 20 has front and rear sides 22 and 24. The front and rear sides 22 and 24 are spaced from one another by a thickness 26 of less than 3 mm. The front and rear sides 22 and 24 each have a width 28 of between 50 and 70 mm and a depth into the paper of between 50 and 70 mm. The front and rear sides 22 and 24 are planar surfaces that are in parallel planes to one another. The material of the waveguide 20 is sufficiently soft to allow for the front and rear sides 22 and 24 to be formed at room temperature of 22° C. or at a moderately high temperature of 50° C. without the formation of microcracks or optical distortions within the material of the waveguide 20.

FIG. 1B illustrates the waveguide 20 after the front and rear sides 22 and 24 have been shaped. The front side 22 is shaped to have a plurality of recesses 30 and a plurality of raised formations 32, with each raised formation 32 being located between two of the recesses 30. Side walls 34 of the recesses 30 form side walls of the raised formations 32. The raised formations 32 have outer surfaces 36 that are in the same plane. The recesses 30 have trench surfaces 38 that are in the same plane and parallel to the plane of the outer surfaces 36. Each recess 30 has a width 40 that is between 10 nm and 500 nm. The rear side 24 is shaped to have a plurality of recesses 44 and a plurality of raised formations 46, with each raised formation 46 being located between two of the recesses 44. Side walls 48 of the recesses 44 form side walls of the raised formations 46. The raised formations 46 have outer surfaces 50 that are in the same plane. The recesses 44 have trench surfaces 52 that are in the same plane that is parallel to the plane of the outer surfaces 50. Each recess 44 has a width 54 that is between 10 nm and 500 nm.

The front and rear sides 22 and 24 are simultaneously shaped with a tool that imprints the recesses 30 and 44 and the raised formations 32 and 46. The tool has front and rear parts that are made of hardened metal. The front part has a shape that is complementary to the profile that is created on the front side 22 and the rear part has a shape that is complementary to the shape that is created on the rear side 24. The waveguide 20 is inserted between the front and rear parts and an actuator is used to move the front and rear parts towards one another while the surfaces of the parts impart pressure on the front and rear sides 22 and 24 of the waveguide 20. The waveguide 20 is then removed from the tool. The front and rear sides 22 and 24 are then etched. The etching process removes microscopic artifacts from the trench surfaces 38 and 52 and planarizes the trench surfaces 38 and 52.

A thickness 58 of the waveguide 20 as measured between the outer surfaces 36 and 50 is more than the thickness 26 of the substrate in FIG. 1A and a thickness 60 as measured between the trench surfaces 38 and 52 is less than the thickness 26. The waveguide 20 has a thickness of between 200 microns and 1 nm. Each recess 30 or 44 has a depth 62 of between 10 nm and 500 nm.

FIG. 1C illustrates the waveguide 20 after a porogen (sacrificial) material is deposited. The porogen material may be spin coated on the front side 22 and the rear side 24 of the waveguide 20. The porogen material fills the recesses 30 and 44. The porogen material forms a plurality of separated porogen portions 64 within the recesses 30 on the front side 22 and a plurality of separated porogen portions 66 within the recesses 44 on the rear side 24. Each porogen portion 64 fills a respective recess 30 until an outer surface 68 of the porogen portion 64 is coplanar with the outer surfaces 36 of the raised formations 32. The porogen portions 66 fill the recesses 44 until outer surfaces 70 of the porogen portions 66 are coplanar with the outer surfaces 50 of the raised formations 46.

FIG. 1D illustrates the structure of FIG. 1C after a first front cap layer 74 and a first rear cap layer 76 are formed. The cap layers 74 and 76 may, for example, be formed in a chemical vapor deposition process.

The first front cap layer 74 is made of a select solid transparent material. The first front cap layer 74 is formed directly on the outer surfaces 36 of the raised formations 32 and the outer surfaces 68 of the porogen portions 64. The first front cap layer 74 also adheres to the outer surfaces 36 of the raised formations 32 and is thus secured to the waveguide 20.

The first front cap layer 74 is shown as finally fabricated and is made of a relatively strong solid material. However, the first front cap layer 74 is initially a thin and unstable film during its manufacture. Such a thin film is fragile and would collapse in the absence of the support provided by the solid material of the porogen portions 64. The first front cap layer 74 becomes more stable as it grows thicker and is eventually thick enough so that it does not rely on the support provided by the porogen portions 64 for its structural integrity. The first front cap layer 74 has a plurality of first portions 80 that are formed on the raised formations 32 and a plurality of second portions 82 that are formed on the porogen portions 64.

Similarly, the first rear cap layer 76 relies on the solid material of the porogen portions 66 for support during its initial fabrication but does not require the support of the porogen portions 66 after it has been finally fabricated and has obtained a thickness that is suitable to support itself without requiring the porogen portions 66. The first rear cap layer 76 has a plurality of first portions 84 that are formed on the raised formations 46 and a plurality of second portions 86 that are formed on the porogen portions 66.

FIG. 1E illustrates the structure of FIG. 1D after the porogen portions 64 and 66 are removed to leave respective cavities 88 and 90. Each cavity 88 and 90 has the same dimensions as a respective porogen portion that has been removed. Each cavity 88 and 90 is filled with an optical gas in the form of air.

The solid porogen material of the porogen portions 64 and 66 is a thermally decomposable material or a material mixture that can be decomposed at a temperature that does not cause damage to the waveguide 20, the first front cap layer 74 or the first rear cap layer 76. The entire structure of FIG. 1D is heated to the decomposition temperature, which causes the solid porogen material to be converted to a porogen gas. The material of the first front cap layer 74 and the first rear cap layer 76 is sufficiently porous to allow the porogen gas to penetrate through the first front cap layer 74 and the first rear cap layer 76 so that the porogen gas leaves the cavities 88 and 90, and for air to penetrate through the first front cap layer 74 and the first rear cap layer 76 into the cavities 88 and 90. For example, propylene carbonate (PPC) can be decomposed in an inert atmosphere or in air without leaving an obvious residue behind. It is generally contemplated that the decomposition temperature be between 120° C. and 230° C. If a decomposition temperature of between 200° C. and 300° C. is used, the porogen portions 64 and 66 can be replaced with air within a short amount of time. If the decomposition temperature has to be lowered, it may be possible to add additives or to lengthen the baking time. A decomposition temperature of between 120° C. and 160° C. is possible with a suitable combination of materials, film thicknesses and baking time. The baking temperature and temperature ramp rate need to be carefully controlled so that no significant residue is left behind and so that the rate of release of the porogen gas is controlled in order to not cause damage to the first front cap layer 74 and the first rear cap layer 76, such as popping, sagging and cracking.

When the cavities 88 and 90 are finally formed, the first portions 80 of the first front cap layer 74 and first rear cap layer 76 are secured to and are supported by the raised formations 32 and 46. Each one of the cavities 88 is defined on three sides by surfaces of a respective one of the recesses 30 and on a fourth side by one of the second portions 82 of the first front cap layer 74. Similarly, each one of the cavities 90 is defined on three sides by surfaces of the recesses 44 and on a fourth side by one of the second portions 86 of the first rear cap layer 76. What should be noted is that the second portions 82 and 86 of the first front cap layer 74 and the first rear cap layer 76 are not supported by the porogen portions 64 and 66 anymore. The first front cap layer 74 and the first rear cap layer 76 are however still supported by the raised formations 32 and 46 and, provided that the widths 40 and 54 of the cavities 88 and 90 are each less than 500 nm, the structural integrity of the first front cap layer 74 and the first rear cap layer 76 can be retained during and after outgassing of the solid porogen material.

FIG. 1F illustrates the structure of FIG. 1E after a second front cap layer 94 is formed on the first front cap layer 74 and further front cap layers 96 are sequentially formed on the second front cap layer 94. The second front cap layer 94 provides additional strength to the first front cap layer 74. For better adhesion, an adhesion promoter such as Valmat® or TranSpin® can be used between the first and second front cap layers 74 and 94 and between the second front cap layer 94 and the further front cap layers 96.

The second front cap layer 94 and further front cap layers 96 are made of different select transparent materials. One or more of the materials of the first, second and further front cap layers 74, 94 and 96 are selected to have refractive indices that promote absorption of light and reduce reflection of light. In a practical example, the first front cap layer 74 is made of SiOx having a refractive index of 1.45, the second front cap layer 94 is made of TiOx having a refractive index of between 2.2 and 2.3, a third front cap layer is made of SiOx, and a fourth front cap layer is made of TiOx, wherein “x” is variable.

FIG. 1F also illustrates the structure of FIG. 1E after a second rear cap layer 98 is formed on the first rear cap layer 76 and further rear cap layers 100 are sequentially formed on the second rear cap layer 98. The second rear cap layer 98 provides additional strength to the first rear cap layer 76. For better adhesion, an adhesion promoter such as Valmat® or TranSpin® can be used between the first and second rear cap layers 76 and 98 and between the second rear cap layer 98 and the further rear cap layers 100.

The second rear cap layer 98 and further rear cap layers 100 are made of different select transparent materials. One or more of the materials of the first, second and further rear cap layers 76, 98 and 100 are selected to have refractive indices that promote absorption of light and reduce reflection of light. In a practical example, the first rear cap layer 76 is made of SiOx having a refractive index of 1.45, the second rear cap layer 98 is made of TiOx having a refractive index of between 2.2 and 2.3, a third rear cap layer is made of SiOx, and a fourth front rear layer is made of TiOx, wherein “x” is variable.

FIG. 1G further shows a source 102 of ambient light and a projector 106. The source 102 of ambient light may for example be an object that reflects ambient light. The ambient light is represented by beams 104A and 104B. Each beam 104A and 104B transmits through environmental air, and then sequentially passes through the front cap layers 96, 94 and 74, through the waveguide 20 and through the rear cap layers 76, 98 and 100. The indices of refraction between adjacent cap layers is minimized to minimize reflection of the ambient light and to promote absorption of the ambient light into the waveguide 20. The beam 104A also passes through air in one of recesses 44 in the rear side 24 of the waveguide 20. The beam 104B passes through air in one of the recesses 30 in the front side 22 of the waveguide 20.

The projector 106 generates projected light represented by the beam 104C. The beam 104C is inserted into the waveguide 20. The beam 104C may for example be inserted through the rear cap layers 100, 98 and 76 and their indices of refraction are selected to promote absorption and to limit reflection of the beam 104C. The beam 104C is directed to one of the recesses 30 in the front side 22. A difference between the index of refraction of the waveguide 20 and the index of refraction of the air in the recess 30 is maximized to promote reflection of the beam 104C and to limit transmission of the beam 104C into the air in the recess 30. The air has an index of refraction of 1 and the waveguide 20 may have an index of refraction of at least 1.74. The indices of refraction thus differ from one another by at least 0.74. In another embodiment, another optical gas may be used instead of air, provided that such an optical gas has an index of refraction of less than 1.3. Ideally, the indices of refraction between the material of the waveguide 20 and the optical gas should be at least 0.50. The beam 104C that is reflected from the air in one of the recesses 30 subsequently transmits to one of the recesses 44 in the rear side 24 of the waveguide 20. The beam 104C reflects from the interface between the air in the recess 44 towards another one of the recesses 30 in the front side 22 of the waveguide 20. An alternate structure can be a direct imprint pattern using Si containing resist over a spin coated paraben material that is then evaporated. The Si containing resist can be plasma treated to form a SiOx polymer structure.

Reflection of an air interface significantly improves optical image quality by changing optical artifacts such as 1) improving overall transmissivity of world light through the ‘transparent’ eye-piece, making world side objects clearer and brighter; 2) maintaining an index difference between relief structure trench versus grating height, allowing high diffraction efficiency of grating constituting the function waveguide relief structure; 3) reducing ghost artifacts from reflection of light exiting the eye piece and reflecting back from different lens or stacked waveguide interfaces; and 4) reducing outside light from diffraction into to the users' eye box and creating rainbow defects which otherwise are much stronger without the nano-feature and film stack architecture.

FIGS. 1A to 1G illustrate one example of creating an anti-reflective cap structure. Anti-reflective properties can also be manufactured using alternative methods. FIG. 1H illustrates an optical system wherein front and rear patterned layers 120 and 122 are formed on front and rear sides of a waveguide 20. The layers 120 and 122 may be patterned using a conventional photo-lithographic technique and are made of a polymer or a photoresist material that is suitable for patterning using photo-lithography. No additional etch step is required. The layers are then coated with front and rear conformal layers 124 and 126 respectively. The conformal layers are made of inorganic SiOx and are formed using chemical vapor deposition. The conformal layers 124 and 126 define recesses 30 and 44 and the recesses 30 and 44 are covered with front and rear cap layers 74 and 76.

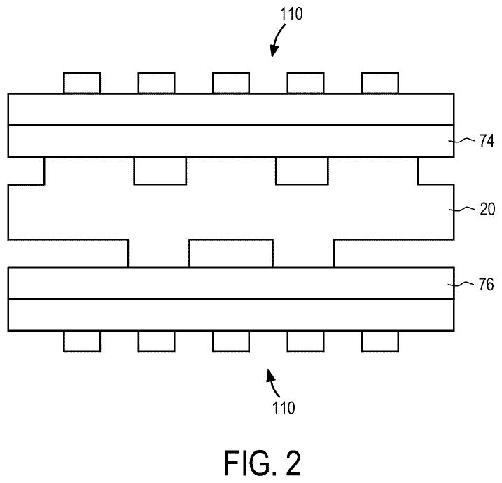

FIG. 2 illustrates an alternate structure wherein nanopatterning 110 is carried out on an external surface instead of multiple cap layers as described in FIG. 1F. The nanopatterning 110 reduces reflection of ambient light and promotes absorption of ambient light. FIG. 2 has reference numerals that are similar to the reference numerals used in FIG. 1F and like reference numerals indicate like or similar components.

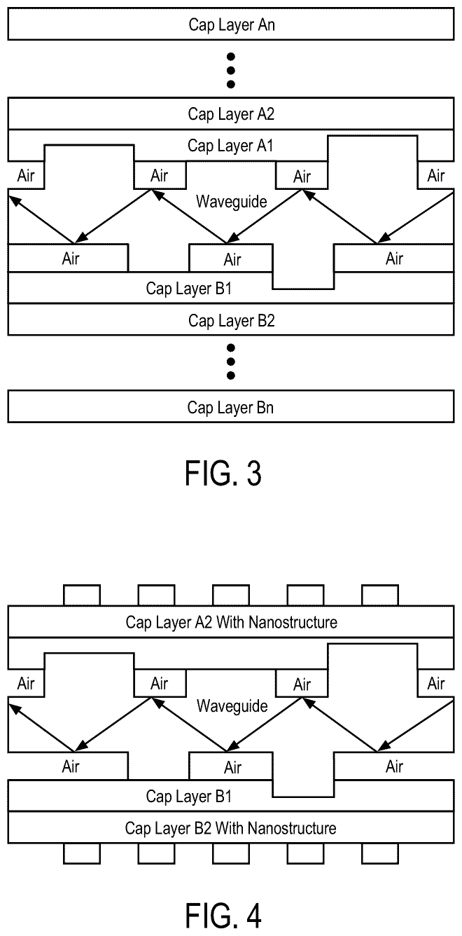

FIGS. 3 and 4 are similar to FIGS. 1F and 2. The optical systems illustrated in FIGS. 3 and 4 have waveguides with variable height or “duty cycle”. The porogen material can be formed in such structures in a spin coating operation as described before.

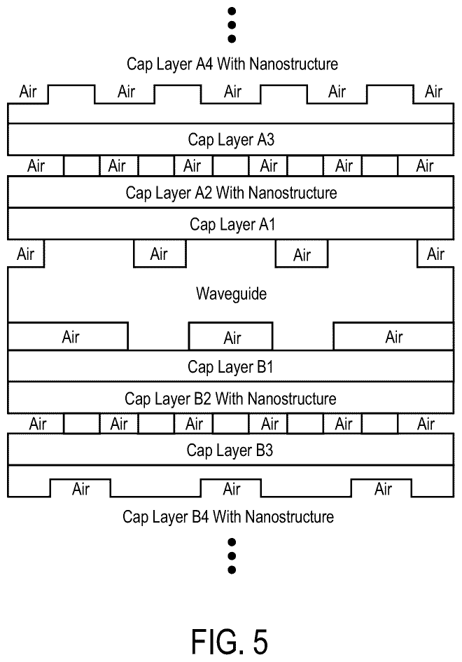

FIG. 5 illustrates a further optical system that has different layers of different of three-dimensional nanostructure stacks. The three-dimensional nanostructure stacks can be designed differently for different waveguide purposes. The materials composition, thicknesses and nanopatterning with various spatial and geometric configurations for each cap layer can be different or the same from one layer to the next.

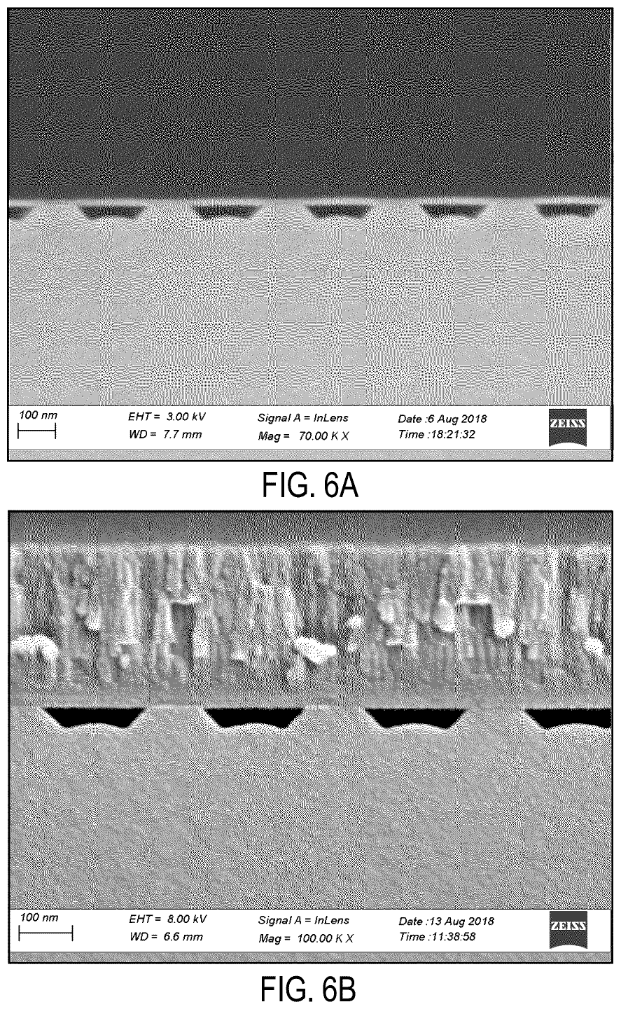

FIG. 6A illustrates a scanning electron microscope (SEM) image of a capped air pocket with a single layer of SiOx over etched grating in high index glass. FIG. 6B shows an SEM image of a capped air pocket with multi-layered coatings. The multi-layered coatings alternate between SiOx and TiOx with different thicknesses for each layer. The composition and thicknesses of the layers on top of the gratings, from bottom to top, are 20 nm porous SiOx, 15 nm TiOx, 65 nm SiOx, 34 nm TiOx, 18 nm SiOx, 59 nm TiOx, 97 nm SiOx. The multi-layer coatings on top of the air pocket structure can be applied by chemical and/or physical vapor deposition or spin coating or a combination of different coating techniques.

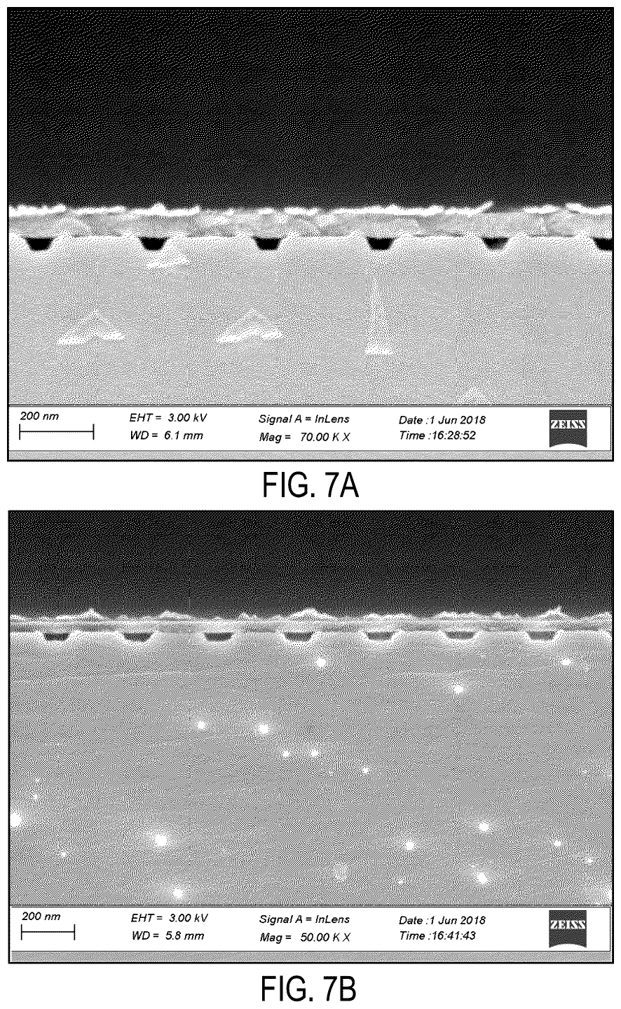

FIGS. 7A and 7B show a sample with air pocket capped first with a SiOx layer and then spin coated with an optical polymer with refractive index 1.31 (Teflon AF1600 from the Chemours Company). The air pockets reduced the effective refractive index of the nanostructured grating area, leading to a gradual refractive index change from the bulk substrate to the surface grating area to the SiOx cap layer to the spin coated optical polymer layer and finally to the air. This kind of gradual refractive index change is beneficial for anti-reflection purpose and can significantly enhance the transmission of ambient light.

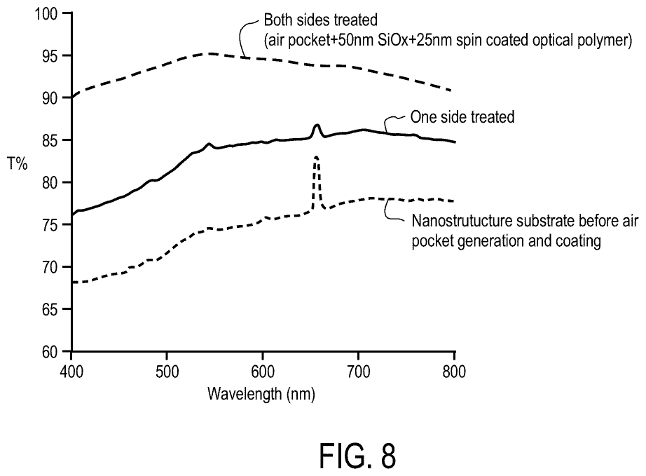

FIG. 8 is a 0° transmission graph from experimental measurement showing that the transmission is significantly increased by the combination of air pockets and coatings in FIGS. 7A and 7B. The nanostructured substrate here is a high-index lithium niobate substrate etched to form surface gratings.

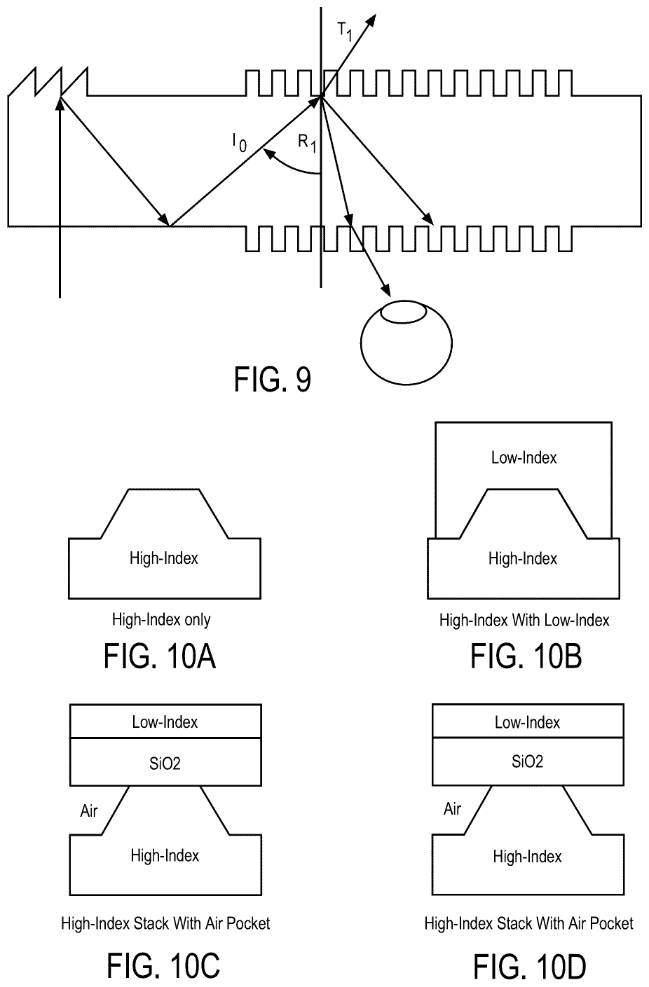

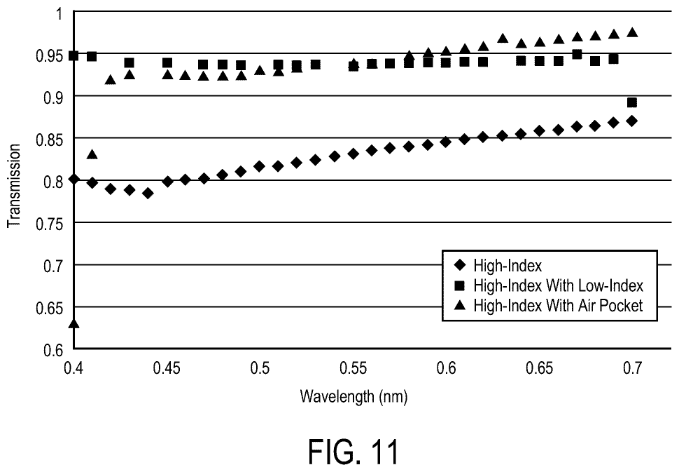

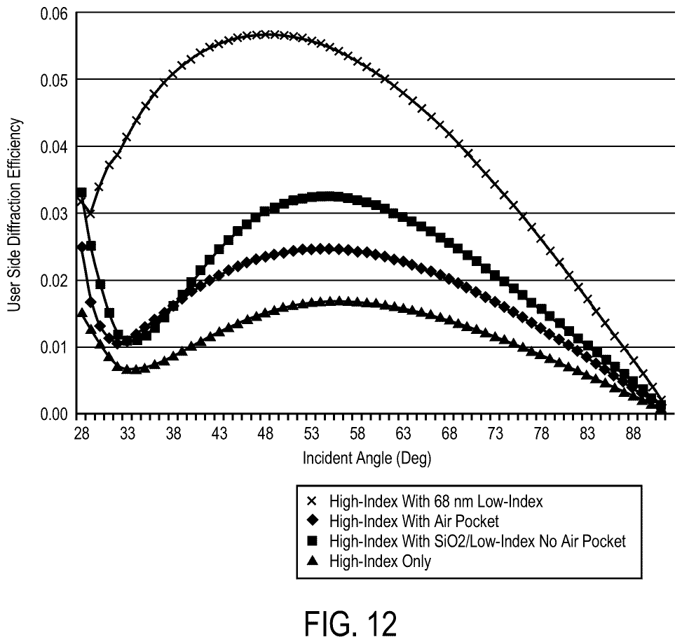

FIG. 9 illustrates a model that is used for purposes of simulation of reflective properties. FIGS. 10A to 10D show four different anti-reflective coating stacking configurations that are simulated within the structure of FIG. 9. FIG. 10A is a side view of a waveguide without any coatings for the simulation. FIG. 10B is a side view of a waveguide with an optical polymer coating for the simulation. FIG. 10C is a side view of a waveguide with an air pocket for the simulation. FIG. 10D is a side view of a waveguide with a polymer instead of an air gap for the simulation. FIG. 11 is a graph that illustrates transmission data based on the simulation. FIG. 12 shows user-side diffraction efficiency from the simulation using high-index lithium niobate for the waveguide. It can be seen that for the simulated transmission data, directly spun-on low refractive index optical polymer (AF2400 from the Chemours Company, index 1.29) has a similar effect on enhancing the transmission compared to a configuration with an air pocket. However, for single bounce diffraction efficiency, the air pocket configuration is significantly better than the configurations that have only the spin-on low index polymer or with the stack with PPC fill the trench of the grating. The simulation shows that the diffraction efficiency is significantly higher than the situation with low index materials fill the trench, though still lower than the situation without any anti-reflective coatings applied. In order to further boost the efficiency, the grating geometry needs to be changed accordingly.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of manufacturing an optical system comprising:
securing a cap layer of a select transparent material to a waveguide of a high-index transparent material having front and rear sides by forming a stack that includes the waveguide, a solid porogen material and the cap layer, multiple cavities being defined between the cap layer and the waveguide, the cavities alternated with raised formations, with the solid porogen material in each cavity;
heating the solid porogen material to a decomposition temperature wherein the solid porogen material turns into a sacrificial gas in each cavity;
simultaneously removing the sacrificial gas from the cavities, wherein the select material of the cap layer is porous and the sacrificial gas outgasses through the select material of the cap layer; and
simultaneously replacing the solid porogen material with an gaseous body in cavity, such that, if a source of ambient light is located on the front side of the waveguide, a beam of the ambient light transmits in the select transparent material of the cap layer, in the cavity holding the gaseous body and in the high-index transparent material of the waveguide, and if a beam of projected light is introduced to the waveguide, the beam of projected light is transmitted internally inside the waveguide by reflecting off walls of the waveguide defined by the cavities.

2. The method of claim 1, wherein the cap layer is a front cap layer located between the source of ambient light and the front side of the waveguide and the beam of the ambient light transmits sequentially through the select transparent material of the front cap layer, through the cavity holding the gaseous body and into the high-index transparent material of the waveguide.

3. The method of claim 2, wherein the select transparent material of the front cap layer is an anti-reflective material that increases absorption of the ambient light by the front surface of the waveguide and reduces reflection of the ambient light by the front surface of the waveguide.

4. The method of claim 3, wherein the high-index transparent material is one of high-index glass, high-index lithium niobate, lithium tantalite and silicon carbide.

5. The method of claim 3, wherein the high-index transparent material has a refractive index of at least 1.74.

6. The method of claim 1, wherein the gaseous body has an index of refraction of less than 1.3.

7. The method of claim 1, wherein the gaseous body is air with an index of refraction of claim 1.

8. The method of claim 1, wherein the solid porogen material decomposes at a decomposition temperature of between 120° C. and 230° C.

9. The method of claim 1, wherein the cap layer is made of SiOx having a thickness of at least 12 nm, wherein x is variable.

10. The method of claim 1, further comprising:
forming the front side of the waveguide to have a plurality of recesses and a plurality of raised formations, each raised formation being located between two of the recesses; and
supporting first portions of the cap layer with the raised formations with second portions of the cap layer that are located between the first portions of the cap layer being located over the recesses to that a respective one of the cavities is defined by a respective on of the second portions of the cap layer and a respective one of the recesses in the front side of the waveguide.

11. The method of claim 10, wherein each recess has a depth and a width and the width is less than 300 microns.

12. The method of claim 10, wherein the recesses are imprinted on the front side.

13. The method of claim 10, further comprising:
conformally depositing a transparent layer on the front side of the waveguide.

14. The method of claim 1, wherein the cap layer is a front cap layer located between the source of ambient light and the front side of the waveguide and the cavity is a front cavity between the front cap layer and the front side of the waveguide, further comprising; securing a rear cap layer of a select transparent material to the waveguide, a rear cavity being defined between the rear cap layer and the rear of the waveguide with an gaseous body in the rear cavity, such that, if a source of ambient light is located on the front side of the waveguide, a beam of the ambient light transmits in the high-index transparent material of the waveguide, in the rear cavity holding the gaseous body and in the select transparent material of the rear cap layer.

15. The method of claim 1, wherein the cap layer is a first cap layer and the select transparent material is a first select transparent material, further comprising:
securing a second cap layer of a second select transparent material to the first cap layer.

16. The method of claim 15, wherein the second cap layer is more rigid than the first cap layer.

17. The method of claim 15, wherein at least one of the select transparent materials of the cap layers is an anti-reflective material that increases absorption of the ambient light by the front surface of the waveguide and reduces reflection of the ambient light by the front surface of the waveguide.

18. The method of claim 17, further comprising:
forming a stack of cap layers having refractive indices that alter in magnitude.

19. The method of claim 18, wherein the cap layers are made of SiOx having a refractive index of 1.45 and TiOx having a refractive index between 2.2 and 2.3, wherein x is variable.

20. An optical system comprising:
a waveguide of a high-index transparent material having front and rear sides;
a cap layer of a select transparent material secured to the waveguide, multiple cavities being defined between the cap layer and the waveguide, the cavities alternated with raised formations; and
an gaseous body in the cavity, such that, if a source of ambient light is located on the front side of the waveguide, a beam of the ambient light transmits in the select transparent material of the cap layer, in the cavity holding the gaseous body and in the high-index transparent material of the waveguide, and if a beam of projected light is introduced to the waveguide, the beam of projected light is reflected off walls of the waveguide defined by the cavities.
